(19) United States
(12) Patent Application Publication
(10) Pub. No.: US 2026/0063800 A1
(43) Pub. Date: Mar. 5, 2026

(54) DISTANCE MEASURING APPARATUS, DISTANCE MEASURING CONTROL METHOD, AND STORAGE MEDIUM

(71) Applicant: CANON KABUSHIKI KAISHA, Tokyo (JP)

(72) Inventor: KOSUKE NOBUOKA, Kanagawa (JP)

(21) Appl. No.: 19/306,861

(22) Filed: Aug. 21, 2025

(30) Foreign Application Priority Data
Aug. 27, 2024 (JP) 2024-145654

(51) Int. Cl. G01S 17/10; G01S 7/484; G01S 17/89; G01S 7/51

(52) U.S. Cl. CPC G01S 17/10; G01S 7/484; G01S 17/89; G01S 7/51

(57) ABSTRACT

A distance measuring apparatus includes first and second imaging units that capture an image within first and second angles of view, respectively, first and second distance measuring units that perform distance measurement for a target included within the first and second angles of view, respectively, and one or more processors that operate to perform control regarding distance measurement to detect distance measurements for a common target by the first and second distance measuring units using first data generated with the first imaging unit and second data generated with the second imaging unit when the second distance measuring unit different from the first distance measuring unit also performs distance measurement for the target included within the second angle of view to be captured by the second imaging unit.

### BACKGROUND

### FIELD OF THE TECHNOLOGY

The disclosure relates to one or more embodiments of a distance measuring apparatus for measuring a distance to a target (object).

### DESCRIPTION OF THE RELATED ART

Electronic apparatuses such as smartphones, tablets, and digital cameras have Light Detection and Ranging or Laser Imaging Detection and Ranging (LiDAR), which irradiates a target with laser light and measures a distance to the target using the reflected light. In a case where the distance measurement is simultaneously performed to the same target (common target) using a plurality of electronic apparatuses, the distance measurement results may have errors if one electronic apparatus receives the reflected light of the laser light irradiated from the target by another electronic apparatus. This is called mutual interference of LiDAR.

Japanese Patent Application Laid-Open No. 2021-535406 discloses a technology for preventing mutual interference by separating the irradiation timing of the laser light and the reception timing of the reflected light in one electronic apparatus (camera) from those in another electronic apparatus.

### SUMMARY

One or more embodiments of a distance measuring apparatus according to one or more aspects of the disclosure may include a first imaging unit that captures an image within a first angle of view, a first distance measuring unit that performs distance measurement for a target included within the first angle of view, a second imaging unit that captures an image within a second angle of view, a second distance measuring unit that performs distance measurement for the target included withing the second angle of view, one or more memories storing instructions, and one or more processors that, upon execution of the instructions, operate to perform control regarding distance measurement to detect distance measurements for a common target by the first distance measuring unit and the second distance measuring unit using first data generated with the first imaging unit and second data generated with the second imaging unit when the second distance measuring unit different from the first distance measuring unit also performs distance measurement for the target included within the second angle of view to be captured by the second imaging unit. Alternatively, one or more processors may operate to perform control regarding distance measurement to change a setting regarding distance measurement of at least one of the first distance measuring unit and the second distance measuring unit based on first data generated using the first imaging unit and second data generated using the second imaging unit when the second distance measuring unit different from the first distance measuring unit also performs distance measurement for the target included within the second angle of view to be captured by the second imaging unit. One or more distance measuring control methods corresponding to the above one or more distance measuring apparatuses also constitute another aspect of the disclosure. A storage medium storing a program that causes a computer to execute the above one or more distance measuring control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of a distance measuring apparatus (camera) according to a first embodiment.

FIG. 2 illustrates simultaneous distance measurement to the same target (common target) using a plurality of image pickup apparatuses according to the first embodiment.

FIG. 3 is a flowchart illustrating processing to be executed in the first embodiment.

FIG. 4 illustrates the specifications of infrared laser in the first embodiment.

FIG. 5 is a block diagram illustrating the configuration of a distance measuring apparatus according to a second embodiment.

FIG. 6 is a flowchart illustrating processing to be executed in the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### FIRST EMBODIMENT

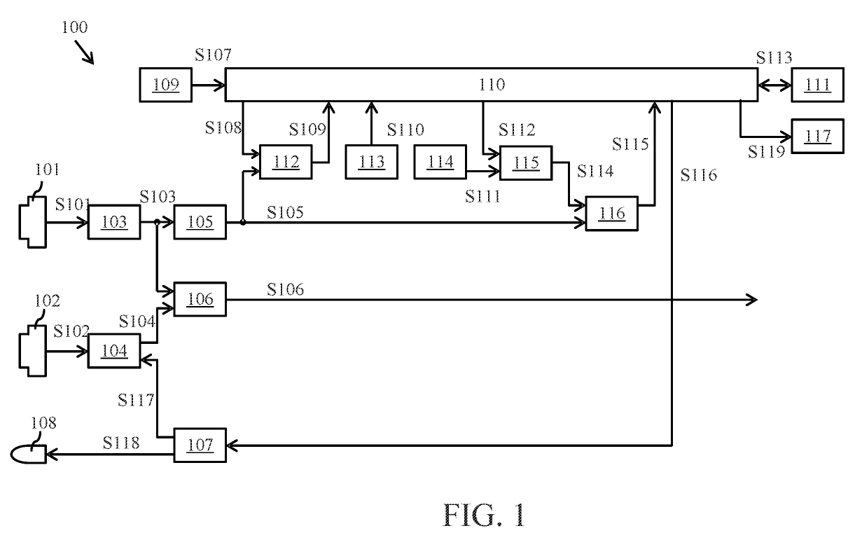

FIG. 1 illustrates the configuration of a first distance measuring apparatus (referred to as a first camera hereinafter) 100 according to a first embodiment. The first camera 100 is mounted on an electronic apparatus such as a smartphone, a tablet, and a digital camera.

In FIG. 1, reference numeral 101 denotes a CMOS sensor (first imaging unit) as an image sensor, reference numeral 102 denotes a LiDAR sensor (first distance measuring unit) as a distance measuring sensor, and reference numeral 103 denotes a visible light image processing circuit. Reference numeral 104 denotes a distance map generating circuit, reference numeral 105 denotes an image recognition circuit, and reference numeral 106 denotes a three-dimensional (3D) model generating circuit. Reference numeral 107 denotes a laser controller, reference numeral 108 denotes an infrared laser array, and reference numeral 109 denotes a proximity sensor. Reference numeral 110 denotes a system controller (control unit), reference numeral 111 denotes a communication unit, reference numeral 112 denotes an encryption circuit, reference numeral 113 denotes a public key data memory, reference numeral 114 denotes a private key data memory, and reference numeral 115 denotes a decryption circuit. Reference numeral 116 denotes a comparison/determination (CD) circuit, and reference numeral 117 denotes a display unit.

A second distance measuring apparatus (referred to as a second camera hereinafter), not illustrated in FIG. 1, includes a CMOS sensor and a LiDAR sensor and has the same configuration as that of the first camera 100. The second camera is also mounted on an electronic apparatus such as a smartphone, a tablet, and a digital camera.

In FIG. 1, S101 represents visible light RAW data, S102 represents LiDAR distance-measurement data, and S103 represents visible light image data. S104 represents distance map data, S105 represents captured image recognition data of the first camera, S106 represents 3D model data, and S107 represents a proximity sensor signal. S108 represents public key data of the second camera, S109 represents encrypted captured image recognition data of the first camera, S110 represents public key data of the first camera, and S111 represents private key data of the first camera. S112 represents encrypted captured image recognition data of the second camera, S113 represents communication packet data, and S114 represents captured image recognition data of the second camera. S115 represents the comparison/determination result, S116 represents a laser controller control signal, and S117 represents pulse-cycle change information. S118 represents a laser pulse control signal, and S119 represents a display control signal for displaying the state of mutual interference.

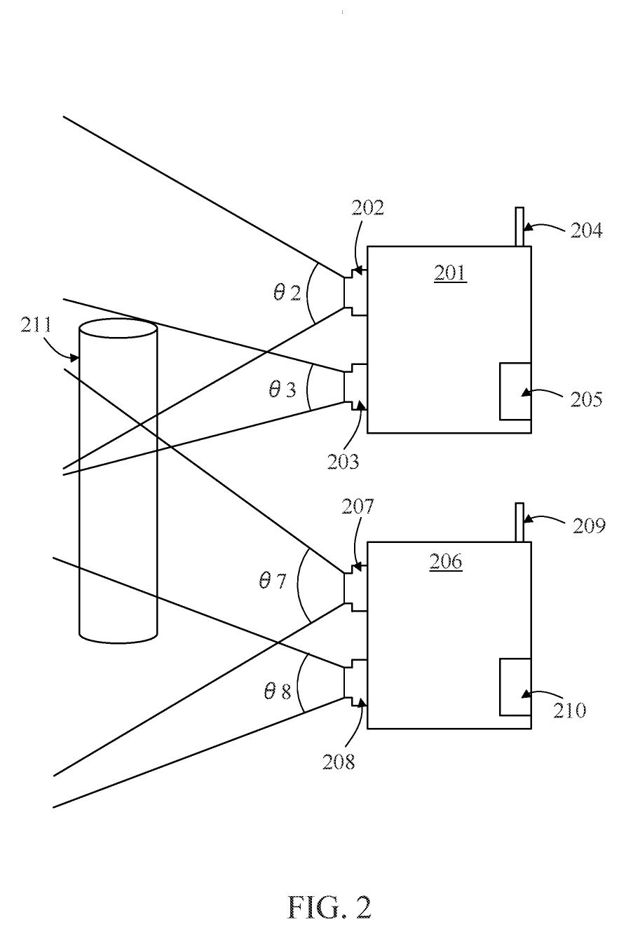

FIG. 2 illustrates a schematic diagram of simultaneous distance measurement to the same target (common target) using LiDAR of each of the first camera 200 and the second camera 206. Reference numeral 202 denotes a CMOS sensor (101) of the first camera 201, and reference numeral 203 denotes a LiDAR sensor (102) of the first camera 201. The CMOS sensor 202 performs imaging within an imaging angle of view θ2 as a first angle of view. The imaging angle of view θ2 of the CMOS sensor 202 and a distance measuring angle of view θ3 of the LiDAR sensor 203 at least partially overlap each other. That is, the LiDAR sensor 203 can measure (detect) a distance to an object (target) included in the imaging angle of view θ2 of the CMOS sensor 202. The imaging angle of view θ2 and the distance measuring angle of view θ3 may be equal to or different from each other. Reference numeral 204 denotes a wireless antenna of the first camera 201, and reference numeral 205 denotes a proximity sensor (109) of the first camera 201.

Reference numeral 207 denotes a CMOS sensor (second imaging unit) of the second camera 206, and Reference numeral 208 denotes a LiDAR sensor (second distance measuring unit) of the second camera 206. The CMOS sensor 207 performs imaging within an imaging angle of view θ7 as the second angle of view. The imaging angle of view θ7 of the CMOS sensor 207 and a distance measuring angle of view θ8 of the LiDAR sensor 208 at least partially overlap each other. That is, the LiDAR sensor 208 can measure a distance to an object (target) included in the imaging angle of view θ7 of the CMOS sensor 207. The imaging angle of view θ7 and the distance measuring angle of view θ8 may be equal to or different from each other. Reference numeral 209 denotes a wireless antenna of the second camera 206, and reference numeral 210 denotes a proximity sensor of the second camera 206. Reference numeral 211 denotes an object serving as a target.

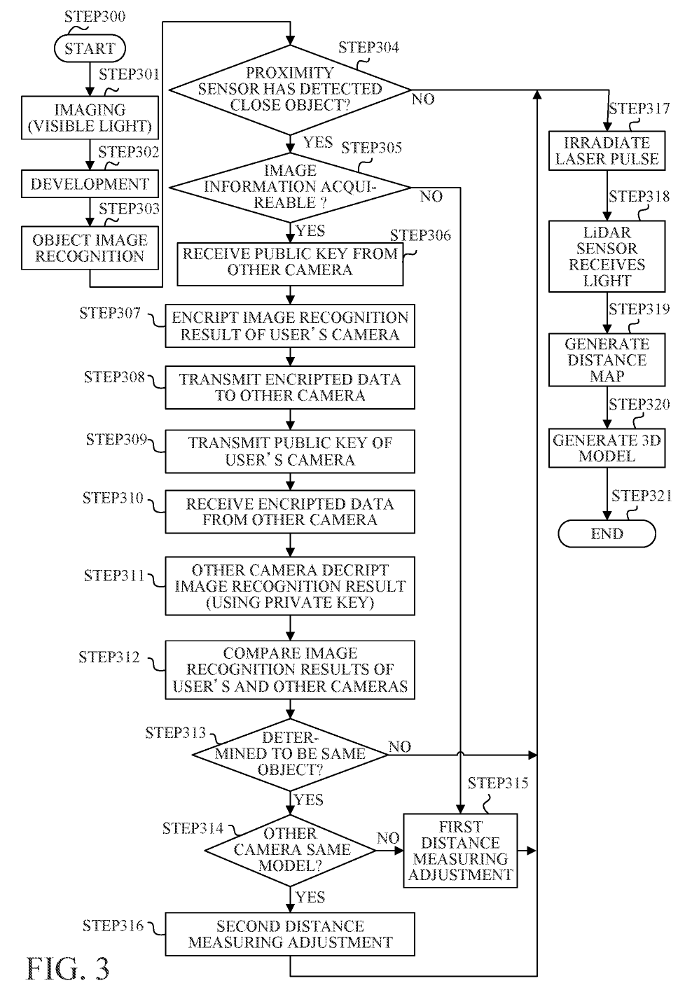

A flowchart in FIG. 3 illustrates processing (distance measuring control method) to be executed by the system controller 110 that includes a computer such as a CPU, in the first camera (user’s camera) 201 according to a program. STEP means the step.

The system controller 110, which has started the processing in STEP 300, causes the CMOS sensor 101 to perform visible light imaging in STEP 301.

Next, in STEP 302, the system controller 110 causes the visible light image processing circuit 103 to perform development processing of the visible light image data.

Next, in STEP 303, the system controller 110 causes the image recognition circuit 105 to perform processing to recognize an object contained in the visible light image data, and generates captured image recognition data (first data) of the user’s camera indicating the result of the object recognition processing.

Next, in STEP 304, the system controller 110 determines whether or not a close object (more specifically, that the second camera is close to the first camera) has been detected by the proximity sensor 109. If a close object has been detected, the system controller 110 performs processing in STEP 305, and if not, the system controller 110 performs processing in STEP 317.

In STEP 305, the system controller 110 determines whether or not image information from the second camera (another camera) can be acquired by communication. In a case where image information can be acquired, the system controller 110 performs processing in STEP 306, and in a case where image information cannot be acquired, the system controller 110 performs processing in STEP 315.

Next, in STEP 306, the system controller 110 receives public key data from the other camera.

Next, in STEP 307, the system controller 110 causes the encryption circuit 112 to encrypt the captured image recognition data of the user’s camera obtained by the image recognition circuit 105.

Next, in STEP 308, the system controller 110 transmits the encrypted captured image recognition data of the user’s camera to the other camera via the communication unit 111.

Next, in STEP 309, the system controller 110 transmits the public key data of the user’s camera to the other camera.

Next, in STEP 310, the system controller 110 receives the encrypted captured image recognition data of the other camera (second data), from the other camera.

Then, in STEP 311, the system controller 110 causes the decryption circuit 115 to decrypt the received encrypted captured image recognition data of the other camera.

Next, in STEP 312, the system controller 110 causes the comparison/determination circuit 116 to compare the captured image recognition data of the user’s camera and the captured image recognition data of the other camera with each other.

Next, in STEP 313, the system controller 110 causes the comparison/determination circuit 116 to determine whether or not the 3D model object included in the captured image recognition data of the user’s camera is the same as the 3D model object included in the captured image recognition data of the other camera. In other words, the system controller 110 causes the comparison/determination circuit 116 to determine whether or not distance measurement is performed for the same object using the user’s camera and the other camera. In a case where the 3D model objects are the same, the flow proceeds to processing of STEP 314, and in a case where they are not the same, the flow proceeds to processing of STEP 317.

In STEP 314, the system controller 110 determines whether or not the user’s camera and the other camera are cameras with the same specifications for the distance measurement (referred to as cameras of the same model hereinafter). In a case where they are not the same model, the flow proceeds to first distance measuring adjustment in STEP 315. In a case where the cameras are of the same model, the flow proceeds to second distance measuring adjustment in STEP 316. That is, different distance measuring adjustments are performed (distance measuring settings are changed) according to whether the user’s camera and the other camera are of the same model or not.

In STEP 315, the system controller 110 causes the laser controller 107 to adjust an emission period (pulse period) and intensity of the infrared laser light (pulsed light) from the infrared laser array 108 as the first distance measuring adjustment. Then, the flow proceeds to processing of STEP 317.

In STEP 316, the system controller 110 causes the laser controller 107 to adjust a distance measuring duration, a distance measuring cycle, and a distance measuring start timing as the second distance measuring adjustment. Then, the flow proceeds to processing of STEP 317.

In STEP 317, the system controller 110 causes the laser controller 107 to irradiate pulsed light from the infrared laser array 108 toward the 3D model object.

Next, in STEP 318, the system controller 110 causes the LiDAR sensor 102 to receive the pulsed light as reflected light.

Next, in STEP 319, the system controller 110 causes the distance map generating circuit 104 to generate a distance map.

Next, in STEP 320, the system controller 110 causes the 3D model generating circuit 106 to generate a 3D model. Then, the flow proceeds to STEP 321 to end this processing.

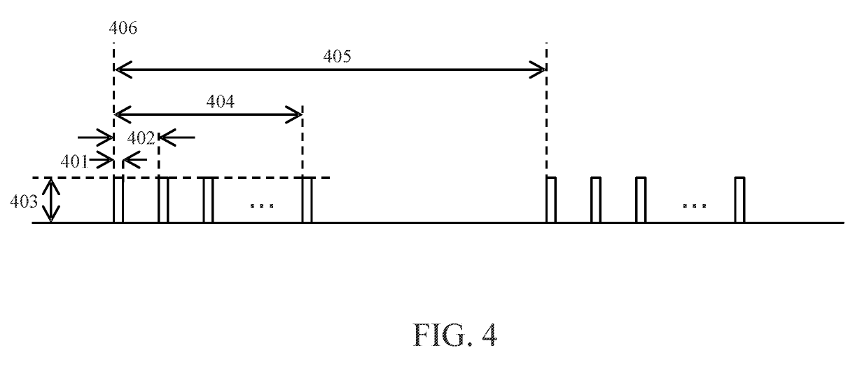

FIG. 4 illustrates pulsed light emitted from the infrared laser array 108 and received by the LiDAR sensor 102 (203). Reference numeral 401 denotes a pulse width of the pulsed light, reference numeral 402 denotes a pulse cycle, and reference numeral 403 denotes the intensity of the pulsed light (referred to as laser intensity hereinafter). Reference numeral 404 denotes a distance measuring duration as a light receiving duration by the LiDAR sensor 102, reference numeral 405 denotes a distance measuring cycle, and reference numeral 406 denotes a distance measuring start timing.

The processing of each step in FIG. 3 and the details of each data in FIG. 2 will be described below. First, in STEP 300, the processing for generating a 3D model starts.

In STEP 301, the CMOS sensor 202 (101) of the first camera 201 images (captures) the object 211, which is a target for generating the 3D model. Thereby, the visible light RAW data S101 is output and is input into the visible light image processing circuit 103.

In STEP 302, the visible light image processing circuit 103 performs development processing, thereby generating visible light image data S103 as a first captured image. The visible light image data S103 is input into the image recognition circuit 105 and the 3D model generating circuit 106.

In STEP 303, the image recognition circuit 105 performs the image recognition processing, and consequently, captured image recognition data S105 of the user’s camera is generated. The captured image recognition data S105 is input into the encryption circuit 112 and the comparison/determination circuit 116. The captured image recognition data S105 is data that represents a unique characteristic of the object 211, and is generated by a known technology, such as processing using a deep learning Convolutional Neural Network (CNN).

In STEP 304, the proximity sensor 205 (109) generates the proximity sensor signal S107 indicating whether or not another camera (LiDAR sensor 208) is present near the user’s camera (LiDAR sensor 203). The proximity sensor signal S107 is input into the system controller 110.

The proximity sensor 109 detects the presence of the other camera near the user’s camera, for example, by detecting electromagnetic waves in the 6 GHz frequency band that is used in 5G (fifth generation mobile communication system). In a case where the other camera is present near the user’s camera, that is, in a case where an environment in which distance measurement is performed for the same object 211 by a plurality of cameras is detected, the flow proceeds to the processing of STEP 305. On the other hand, in a case where the other camera is not present near the user’s camera, that is, in a case where the environment in which distance measurement is performed for the same object 211 by the plurality of cameras is not detected, the flow proceeds to the processing of STEP 317.

In STEP 305, the system controller 110 determines whether or not image information can be acquired from the other camera through the communication unit 111 (whether or not it is possible to start communication with the other camera). For example, the system controller 110 transmits a command to the other camera to request the start of communication. In a case where a response is received from the other camera within a predetermined time, it is determined that communication can be started, and in a case where no response is received, it is determined that communication cannot be started. In a case where it is determined that image information can be obtained from the other camera, the flow proceeds to STEP 306. On the other hand, in a case where it is determined that image information cannot be obtained from the other camera, the flow proceeds to STEP 315.

The processing from STEP 306 to STEP 311 is general encryption processing. In STEP 306, the system controller 110 executes processing of receiving the public key data of the other camera by the communication packet data S113 via the communication unit 111. The public key data S108 of the other camera is input into the encryption circuit 112.

In STEP 307, the encryption circuit 112 encrypts the captured image recognition data S105 of the user’s camera using the public key data S108 of the other camera. The encrypted captured image recognition data S109 of the user’s camera is input into the system controller 110.

In STEP 308, the system controller 110 transmits the captured image recognition data S109 of the user’s camera, encrypted using the communication packet data S113, to the other camera. Thus, the captured image recognition data S105 of the user’s camera is encrypted and transmitted to the other camera, where it is used for processing in the other camera.

In STEP 309, the system controller 110 transmits the public key data S110 of the user’s camera, which has been previously stored in the public key data memory 113, to the other camera using communication packet data S113. The other camera performs similar processing as in STEP 306 to STEP 308.

In STEP 310, the system controller 110 acquires the encrypted captured image recognition data S112 of the other camera through the communication packet data S113. The captured image recognition data S112 of the other camera indicates the image recognition processing result for the visible light image data as the second captured image generated by imaging with the CMOS sensor 207 in the other camera. The image recognition data S112 is input into the decryption circuit 115.

In STEP 311, the decryption circuit 115 performs decryption processing for the encrypted captured image recognition data S112 of the other camera using the private key data S111 of the user’s camera previously stored in the private key data memory 114. Thereby, the decrypted captured image recognition data S114 of the other camera is generated. The encrypted captured image recognition data S112 of the other camera has been encrypted by the other camera using the public key data S110 of the user’s camera, and thus can be only decrypted using the private key data S111 of the user’s camera.

In STEP 312, the comparison/determination circuit 116 compares the captured image recognition data S105 of the user’s camera and the captured image recognition data S114 of the other camera with each other. Thereby, the comparison/determination result S115 is generated and input into the system controller 110. This comparison processing is performed by a known technology, such as processing by the deep learning CNN.

In STEP 313, the system controller 110 performs the following branching processing based on the comparison/determination result S115. In a case where the comparison/determination result S115 indicates that the captured image recognition data S105 of the user’s camera and the captured image recognition data S114 of the other camera are equivalent, it is determined (detected) that the object for which the 3D models are generated in the user’s camera and the other camera, i.e., the targets for which LiDAR distance measurement is performed, are the same. In this case, the processing of STEP 314 is performed. On the other hand, in a case where the comparison/determination result S115 indicates that the captured image recognition data S105 of the user’s camera and the captured image recognition data S114 of the other camera are not equivalent, it is determined that the targets for which LiDAR distance measurement is performed in the user’s camera and the other camera are different. In this case, the flow proceeds to the processing of STEP 317.

In STEP 314, the system controller 110 executes the following processing. The system controller 110 performs a predetermined communication with the other camera through the communication packet data S113 and determines whether the other camera is of the same model as the user’s camera. More specifically, the system controller 110 receives ID information (model name, serial number, etc.) from the other camera, compares it with the ID information of the user’s camera, and determines whether the specifications of the LiDAR sensor of the other camera are the same as the specifications of the LiDAR sensor of the user’s camera. In a case where the other camera is not of the same model as the user’s camera, the flow proceeds to the processing of STEP 315, and in a case where they are the same model, the flow proceeds to the processing of STEP 316.

In STEP 315, the system controller 110 performs the following first distance measuring adjustment. The system controller 110 changes the pulse cycle 402 from a default value (predefined value) to the laser controller 107 through the laser controller control signal S116. In this change, the cycle may be increased or reduced.

The setting of the laser intensity 403 may be changed along with the change in the pulse cycle 402. More specifically, in a case where the pulse cycle 402 is reduced, the number of times the laser light is irradiated per unit time increases, so the laser intensity 403 is changed to an intensity that satisfies the Eye-Safe standard of the laser. In a case where the pulse cycle 402 is increased, the number of times the laser light is irradiated per unit time decreases, so the laser intensity 403 can be increased within a range that satisfies the Eye-Safe standard of the laser. In a case where the pulse cycle 402 is changed, the distance measuring duration 404 may be changed so that there is no change in the number of pulses of the laser light that is used for single distance measurement. The distance measuring cycle 405 may be changed in accordance with the change in the distance measuring duration 404.

At this time, the system controller 110 outputs a display control signal S119 to the display unit 117 to display the fact that the LiDARs are in the mutual interference state. This display notifies the user of the influence on the 3D model generation result due to changes in the pulse cycle 402, the distance measuring duration 404, and the distance measuring cycle 405 from the default values.

In STEP 316, the system controller 110 performs the following second distance measuring adjustment. The system controller 110 causes the laser controller 107 to set the distance measuring cycle 405 to a time that is at least twice as long as the distance measuring duration 404 through the laser controller control signal S116. In addition, the system controller 110 performs predetermined communication with the other cameras through the communication unit 111 to make the setting such that the distance measuring start timing 406 of the user’s camera does not overlap the distance measuring start timing of the other camera. The system controller 110 outputs the display control signal S119 to the display unit 117 to notify the user of the influence on the 3D model generation result due to the change in the distance measuring cycle 405 to a time at least twice as long as the distance measuring duration 404.

In STEP 317, the laser controller 107 generates the laser pulse control signal S118 indicating the pulse width 401, the pulse cycle 402, the laser intensity 403, the distance measuring duration 404, the distance measuring cycle 405, and the distance measuring start timing 406, and outputs it to the infrared laser array 108. The infrared laser array 108 has a predetermined number of infrared laser elements two-dimensionally arranged horizontally and vertically. These infrared laser elements are arranged in correspondence with the two-dimensional arrangement of the distance map data S104, which will be described later. The infrared laser elements arranged two-dimensionally in this manner irradiate infrared laser light to the outside in accordance with the laser pulse control signal S118.

In the first case where the other camera does not exist near the user’s camera in STEP 304, the pulse width 401, the pulse cycle 402, the laser intensity 403, the distance measuring duration 404, the distance measuring cycle 405, and the distance measuring start timing 406 remain at the default values. This is also the same in the second case where the user’s camera and the other camera perform distance measurement for different objects in STEP 313. In both the first and second cases, there is no mutual interference of the LiDAR. Therefore, by maintaining the pulse width 401, the pulse cycle 402, the laser intensity 403, the distance measuring duration 404, the distance measuring cycle 405, and the distance measuring start timing 406 to be the default values, the user’s camera can perform LiDAR distance measurement with the optimal distance measuring range, distance measuring resolution, distance measuring accuracy, and distance measuring frequency.

In the third case where the camera cannot start communicating image information with the other camera in STEP 305, the pulse width 401, pulse cycle 402, laser intensity 403, distance measuring duration 404, distance measuring cycle 405, and distance measuring start timing 406 are modified as explained in STEP 315. This is also the same in a fourth case where the user’s camera and the other camera are not the same model in STEP 314. Both the third and fourth cases are in a state where LiDAR mutual interference may occur. In the third case, it is not possible to confirm whether the other camera simultaneously performs distance measurement for the same object 211 as the user’s camera, which would cause mutual interference, but this embodiment makes the above modification with a priority on reducing (or eliminating) mutual interference. The fourth case makes the above modification to the other camera that is not the same model, thereby reducing the influence of the mutual interference as much as possible.

In a fifth case where the user’s camera and the other camera are the same model in STEP 314, the changes discussed in STEP 316 are made to the pulse width 401, pulse cycle 402, laser intensity 403, distance measuring duration 404, distance measuring cycle 405, and distance measuring start timing 406. In the fifth case, mutual interference between LiDARs is highly likely to occur, and the user’s camera and the other camera are the same model, so the changes discussed in STEP 315 are the same for the user’s camera and the other camera. As a result, mutual interference cannot be reduced. Hence, the changes discussed in STEP 316 increase the distance measuring cycle 405 by more than twice, but can reliably reduce mutual interference.

In STEP 318, the LiDAR sensor 203 (102) receives the laser light reflected from the object 211. Thereby, LiDAR distance-measurement data S102 is generated. The LiDAR distance-measurement data S102 may be generated by a known technology using information on the time of flight (TOF) of the laser light emitted from the infrared laser array 108 and reflected by the object 211.

In STEP 319, the distance map generating circuit 104 generates distance map data S104 based on the LiDAR distance-measurement data S102 and the pulse-cycle change information S117 generated by the laser controller 107. The distance map data S104 is configured as a distance map of the same number of two-dimensional positions as that of the infrared laser array 108 by performing histogram processing for the LiDAR distance-measurement data S102 generated by a known technology, and thereby the distance measuring accuracy is improved. The distance map data S104 including the histogram processing may also be generated by a known technology. The pulse-cycle change information S117 is used for the histogram processing.

In STEP 320, the 3D model generating circuit 106 generates and outputs the 3D model data S106 from the visible light image data S103 and the distance map data S104. The 3D model data S106 may also be generated by a known technology.

In STEP 321, generation of the 3D model for the object 211 in the first camera is completed.

This embodiment detects a state in which the user’s camera and the other camera perform the LiDAR distance measurement for the same target, i.e., a state in which LiDAR mutual interference may occur, by comparing captured image information of the user’s camera and the other camera. Thereby, this embodiment can more reliably detect the mutual interference and control the LiDAR distance measurement of the user’s camera (change the LiDAR distance measuring settings), thereby reducing mutual interference.

After determining whether the user’s camera and the other camera are the same model, this embodiment changes the LiDAR mutual interference settings. Thereby, this embodiment can more reliably reduce mutual interference.

This embodiment notifies the user of the influence of the mutual interference reduction measure on the 3D model generation result, so that the user can determine during imaging whether to accept it or to redo the generation of the 3D model.

In this embodiment, control is performed to reduce LiDAR mutual interference in a case where it is detected that the user’s camera and the other camera are performing LiDAR distance measurement for the same target. In contrast, control to reduce LiDAR mutual interference may also be performed in a case where it is detected that the imaging angle of view of the user’s camera and that of the other camera at least partially overlap each other. In addition, this embodiment controls the LiDAR distance measurement of the user’s camera in a case where a state in which LiDAR mutual interference may occur is detected, but may also perform communication from the user’s camera to the other camera so as to control the LiDAR distance measurement of the other camera. Moreover, both the LiDAR distance measurement of the user’s camera and the LiDAR distance measurement of the other camera may be controlled. That is, at least one of the LiDAR distance measurement of the user’s camera and the LiDAR distance measurement of the other camera may be controlled to reduce mutual interference. The above is similarly applicable to a second embodiment described below.

### SECOND EMBODIMENT

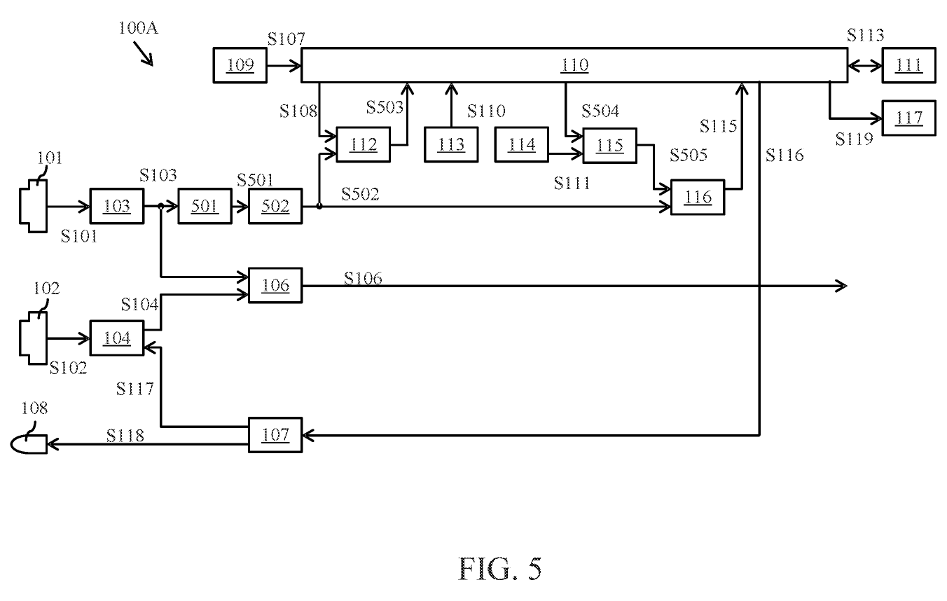

Next, the second embodiment will be described. FIG. 5 illustrates the configuration of a first camera 100A according to the second embodiment. The first camera 100A according to this embodiment includes an image clip (crop or cutout) circuit 501 and an FFT calculation circuit 502 instead of the image recognition circuit 105 illustrated in the first embodiment (FIG. 1).

In this embodiment, the visible light image data S103 output from the visible light image processing circuit 103 is input into the image clip circuit 501, and clipped image data S501 in which a predetermined image range is clipped (cropped or cut out) is generated. The clipped image data S501 is input into the FFT calculation circuit 502. The FFT calculation circuit 502 performs two-dimensional Fast Fourier Transform (FFT) processing for the clipped image data S501, and generates two-dimensional FFT data (first data) S502 indicating the result. The two-dimensional FFT data is image data indicating spatial frequency.

This embodiment uses the two-dimensional FFT data S502 of the first camera output from the FFT calculation circuit 502 in place of the captured image recognition data S105 of the first camera in the first embodiment. This embodiment also uses the encrypted two-dimensional FFT data S503 of the first camera in place of the encrypted captured image recognition data S109 in the first embodiment. Moreover, this embodiment uses encrypted two-dimensional FFT data S504 of the second camera instead of the encrypted captured image recognition data S112 of the second camera in the first embodiment, and uses two-dimensional FFT data (second data) S505 of the second camera instead of the captured image recognition data S114 of the second camera in the first embodiment. Other components and data are the same as those of the first embodiment. The second camera in this embodiment has a configuration similar to that of the first camera in this embodiment.

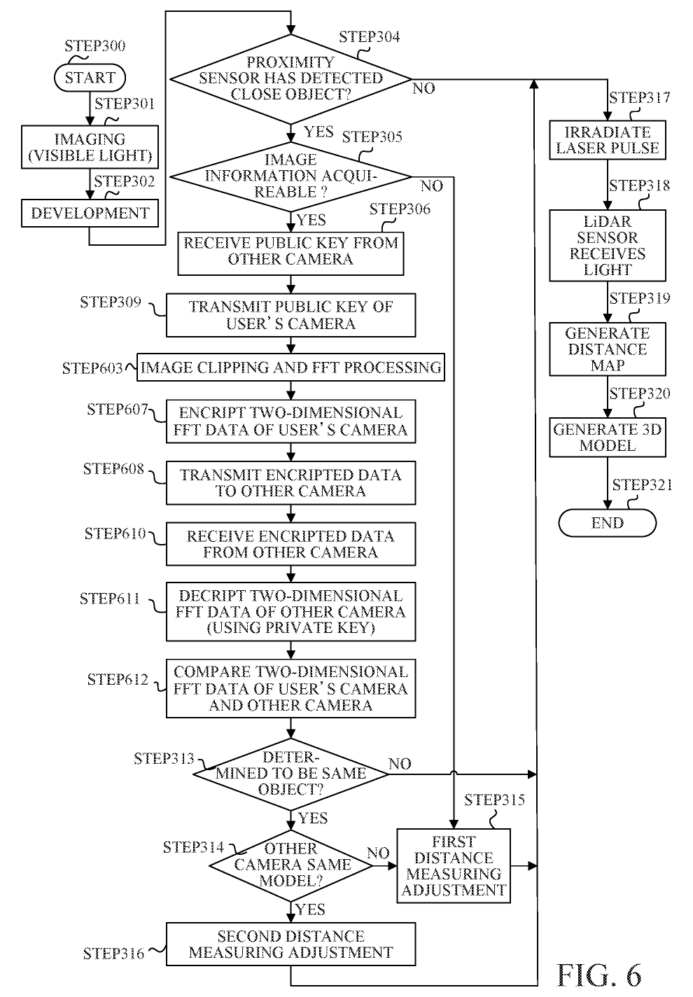

A flowchart of FIG. 6 illustrates processing to be executed by the system controller 110 in the first camera (own camera) according to a program. In this embodiment, STEP 303 of the first embodiment (FIG. 3) is eliminated, STEP 309 is provided after STEP 306, and STEP 603 is provided after STEP 309. STEP 307 of the first embodiment is changed to STEP 607, and STEP 308 is changed to STEP 608. STEP 310 in the first embodiment is changed to STEP 610, STEP 311 is changed to STEP 611, and STEP 312 is changed to STEP 612. The other steps are the same as those of the first embodiment.

After performing the processing from STEP 300 to STEP 306 and further to the next STEP 309, the system controller 110 causes the image clip circuit 501 to clip an image from the visible light image data S103 in STEP 603 to generate clipped image data S501. The clipped image data S501 is input into the FFT calculation circuit 502. The system controller 110 causes the FFT calculation circuit 502 to execute two-dimensional FFT processing for the clipped image data S501. Thereby, two-dimensional FFT data S502 of the user’s camera is generated.

The clipped image data S501 is generated so that the image size is a power of 2 due to the two-dimensional FFT processing of the FFT calculation circuit 502. The two-dimensional FFT data S502 of the user’s camera indicates information on the intensity of the spatial frequency component of the clipped image data S501, and while its information amount is equivalent to that of the clipped image data S501, it has the robust characteristic of not changing against an image shift within a two-dimensional plane.

In the first embodiment, the image recognition circuit 105 generates the captured image recognition data S105 of the user’s camera directly from the visible light image data S103 using the deep learning CNN or the like. In contrast, this embodiment utilizes the robust characteristic of the two-dimensional FFT data S502 of the user’s camera.

Next, in STEP 607, the system controller 110 causes the encryption circuit 112 to encrypt the two-dimensional FFT data S503 of the user’s camera.

Next, in STEP 608, the system controller 110 transmits the encrypted two-dimensional FFT data S503 of the user’s camera to the other camera via the communication unit 111.

Next, in STEP 610, the system controller 110 receives the encrypted two-dimensional FFT data S504 of the other camera from the other camera.

Next, in STEP 611, the system controller 110 causes the decryption circuit 115 to decrypt the received encrypted two-dimensional FFT data S504 of the other camera.

Next, in STEP 612, the system controller 110 causes the comparison/determination circuit 116 to compare the two-dimensional FFT data S502 of the user’s camera and the decrypted two-dimensional FFT data S505 of the other camera with each other. Thereby, the comparison/determination result S115 is generated and input into the system controller 110.

The processing from STEP 603 to STEP 612 may be performed multiple times in small block units, so as to manage the image size of the visible light image data S103 and the image size in the two-dimensional FFT processing. This is because the number of pixels on which the two-dimensional FFT processing is performed is generally smaller than the number of pixels of the image sensor, in terms of the scale of the circuit that performs the processing and the computational load.

The processing from STEP 313 to STEP 320 and the end at STEP 321 are the same as those of the first embodiment.

As described above, this embodiment detects a state in which LiDAR mutual interference may occur by comparing the two-dimensional FFT data of the user’s camera and the two-dimensional FFT data of the other camera with each other. The two-dimensional FFT data has a robust characteristic that it does not change against the image shift within a two-dimensional plane. Thus, this embodiment can more reliably detect and reduce mutual interference than the first embodiment.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can accurately measure a distance to the same target using a plurality of distance measuring units.

This application claims the benefit of Japanese Patent Application No. 2024-145654, which was filed on August 27, 2024, and which is hereby incorporated by reference herein in its entirety.

What is claimed is:

1. A distance measuring apparatus comprising:
a first imaging unit that captures an image within a first angle of view;
a first distance measuring unit that performs distance measurement for a target included within the first angle of view;
a second imaging unit that captures an image within a second angle of view;
a second distance measuring unit that performs distance measurement for the target included within the second angle of view;
one or more memories storing instructions; and
one or more processors that, upon execution of the instructions, operate to perform control regarding distance measurement to detect distance measurements for a common target by the first distance measuring unit and the second distance measuring unit using first data generated with the first imaging unit and second data generated with the second imaging unit when the second distance measuring unit different from the first distance measuring unit also performs distance measurement for the target included within the second angle of view to be captured by the second imaging unit.

2. The distance measuring apparatus according to claim 1, wherein execution of the stored instructions further causes the one or more processors to change a setting regarding the distance measurement to at least one of the first distance measuring unit and the second distance measuring unit the distance measurements for the common target is detected.

3. The distance measuring apparatus according to claim 2, wherein execution of the stored instructions further causes the one or more processors to change the setting so as to reduce mutual interference between the first distance measuring unit and the second distance measuring unit.

4. The distance measuring apparatus according to claim 2, wherein both of the first distance measuring unit and the second distance measuring unit perform the distance measurements by emitting light toward the common target and receiving reflected light from the common target, and
wherein execution of the stored instructions further cause the one or more processors to change a setting regarding light emission of at least one of the first distance measuring unit and the second distance measuring unit.

5. The distance measuring apparatus according to claim 4, wherein execution of the stored instructions further cause the one or more processors to change a setting of at least one of a pulse width of the light, an emission cycle of the light, and an intensity of the light.

6. The distance measuring apparatus according to claim 2, wherein execution of the stored instructions further cause the one or more processors to change a setting of at least one of a distance measuring duration, a distance measuring cycle, and a distance measuring start timing.

7. The distance measuring apparatus according to claim 2, wherein a change of the setting which the one or more processors provides in a case where the first distance measuring unit and the second distance measuring unit have same specifications and a change of the setting which the one or more processors provides in a case where the first distance measuring unit and the second distance measuring unit have different specifications are different.

8. The distance measuring apparatus according to claim 2, wherein execution of the stored instructions further cause the one or more processors to change the setting it is detected that the second distance measuring unit is located near the first distance measuring unit.

9. The distance measuring apparatus according to claim 2, wherein execution of the stored instructions further cause the one or more processors to notify a user in changing the setting.

10. The distance measuring apparatus according to claim 1, wherein the first data and the second data are data indicating a result of object recognition processing on a captured image or data indicating a result of two-dimensional FFT processing to the captured image, respectively.

11. A distance measuring apparatus comprising:
a first imaging unit that captures an image within a first angle of view;
a first distance measuring unit that performs distance measurement for a target included within the first angle of view;
a second imaging unit that captures an image within a second angle of view;
a second distance measuring unit that performs distance measurement for the target included withing the second angle of view;
one or more memories storing instructions; and
one or more processors that, upon execution of the instructions, operate to perform control regarding distance measurement to change a setting regarding distance measurement of at least one of the first distance measuring unit and the second distance measuring unit based on first data generated using the first imaging unit and second data generated using the second imaging unit when the second distance measuring unit different from the first distance measuring unit also performs distance measurement for the target included within the second angle of view to be captured by the second imaging unit.

12. An electronic apparatus comprising:
the distance measuring apparatus according to claim 1.

13. A distance measuring control method using a first distance measuring unit that performs distance measurement for a target included within a first angle of view and a second distance measuring unit that performs distance measurement for the target included within a second angle of view, the distance measuring control method comprising:
performing control regarding distance measurement to detect distance measurements for a common target by the first distance measuring unit and the second distance measuring unit using first data generated with a first imaging unit that captures an image within the first angle of view and second data generated with a second imaging unit that captures an image within the second angle of view when the second distance measuring unit different from the first distance measuring unit also performs distance measurement for the target included within the second angle of view to be captured by the second imaging unit.

14. A distance measuring control method using a first distance measuring unit that performs distance measurement for a target included within a first angle of view and a second distance measuring unit that performs distance measurement for the target included within a second angle of view, the distance measuring control method comprising:
performing control regarding distance measurement to change a setting regarding distance measurement of at least one of the first distance measuring unit and the second distance measuring unit based on first data generated with a first imaging unit that captures an image within the first angle of view and second data generated with a second imaging unit that captures an image within the second angle of view when the second distance measuring unit different from the first distance measuring unit also performs distance measurement for the target included within the second angle of view to be captured by the second imaging unit.

15. A non-transitory computer-readable storage medium storing a program that causes a computer to execute the distance measuring control method according to claim 13.

16. A non-transitory computer-readable storage medium storing a program that causes a computer to execute the distance measuring control method according to claim 14.
